(19) United States
(12) Patent Application Publication
(10) Pub. No.: US 2026/0245164 A1
(43) Pub. Date: Aug. 20, 2026

(54) PARKING LOT MANAGEMENT DEVICE, PARKING LOT MANAGEMENT SYSTEM, PARKING LOT MANAGEMENT METHOD, AND STORAGE MEDIUM

(71) Applicant: HONDA MOTOR CO., LTD., Tokyo (JP)

(72) Inventors: Kazuki YAMANO, Tokyo (JP); Yuki HARA, Tokyo (JP); Jing LI, Tokyo (JP)

(73) Assignee: HONDA MOTOR CO., LTD., Tokyo (JP)

(21) Appl. No.: 19/542,031

(22) Filed: Feb. 17, 2026

(30) Foreign Application Priority Data
Feb. 19, 2025 (JP) 2025-025331

(51) Int. Cl. G06Q 50/40; G01C 21/34

(52) U.S. Cl. CPC G06Q 50/40; G01C 21/3407; G06Q 2240/00

(57) ABSTRACT

A parking lot management device that identifies, from among a plurality of parking frames provided in a parking lot, a parking frame to which a user who desires to use the parking lot is guided, the parking lot management device includes a processor configured to: acquire attribute information indicating an attribute of a vehicle of the user; identify, by referring to a storage that stores parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and perform guidance for the user to the identified parking frame.

### RELATED APPLCATION

This application is based upon and claims the benefit of priority from prior Japanese patent application No. 2025-25331, filed on February 19, 2025, the entire contents of which are incorporated herein by reference.

### TECHNICAL FIELD

The present disclosure relates to a parking lot management device, a parking lot management system, a parking lot management method, and a storage medium storing a program.

### BACKGROUND ART

In recent years, active efforts have been made to provide access to a sustainable transportation system in consideration of vulnerable traffic participants. As one of these efforts, research and development on driving assistance techniques for vehicles such as automobiles have been made in order to further improve safety and convenience of traffic.

For example, JP2023-053667A discloses a vehicle guidance device that parks a vehicle in a parking frame corresponding to a dimension of the vehicle.

### SUMMARY OF INVENTION

However, in a configuration described in JP2023-053667A, for example, various sensors need to be mounted on the vehicle in order to determine a passage through which the vehicle can pass or to detect a parking frame in which the vehicle can be parked, and in such a case, the vehicle cost may increase. Therefore, it is desirable to realize a configuration capable of identifying a parking frame to which a user is guided at low cost.

Aspects of the present disclosure relate to a parking lot management device, a parking lot management system, a parking lot management method, and a storage medium storing a program that can identify a parking frame to which a user is guided at low cost.

According to an aspect of the present disclosure, there is provided a parking lot management device that identifies, from among a plurality of parking frames provided in a parking lot, a parking frame to which a user who desires to use the parking lot is guided, the parking lot management device including a processor configured to:

acquire attribute information indicating an attribute of a vehicle of the user;

identify, by referring to a storage that stores parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and

perform guidance for the user to the identified parking frame.

According to another aspect of the present disclosure, there is provided a parking lot management system that identifies, from among a plurality of parking frames provided in a parking lot, a parking frame to which a user who desires to use the parking lot is guided, the parking lot management system including:

the parking lot management device ; and

a vehicle configured to communicate with the parking lot management device and receive guidance on the parking frame, in which

the vehicle of the user includes a processor configured to receive the guidance on the parking frame from the parking lot management device and issue a notification of information on the parking frame based on the received guidance.

According to another aspect of the present disclosure, there is provided a parking lot management method by a computer that identifies, from among a plurality of parking frames provided in a parking lot, a parking frame to which a user who desires to use the parking lot is guided, including:

acquiring attribute information indicating an attribute of a vehicle of the user;

identifying, by referring to parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and

performing guidance for the user to the identified parking frame.

According to another aspect of the present disclosure, there is provided a non-transitory computer-readable storage medium storing a program causing a computer that identifies, from among a plurality of parking frames provided in a parking lot, a parking frame to which a user who desires to use the parking lot is guided to execute a process, the process including:

acquiring attribute information indicating an attribute of a vehicle of the user,

identifying, by referring to parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user, and

performing guidance for the user to the identified parking frame.

According to the present disclosure, it is possible to identify a parking frame to which a user is guided at low cost. This further improves safety of traffic and contributes to development of a sustainable transportation system.

### BRIEF DESCRIPTION OF DRAWINGS

Exemplary embodiment(s) of the present invention will be described in detail based on the following figures, wherein:

FIG. 1 is a block diagram illustrating an example of a configuration of a parking lot management system 100 according to an embodiment;

FIG. 2 is a diagram illustrating an example of parking statistical information 220a;

FIG. 3 is a sequence chart illustrating an example of processing executed in the embodiment; and

FIG. 4 is a flowchart illustrating an example of processing (update processing of the parking statistical information) executed in a parking lot management device 200.

### DESCRIPTION OF EMBODIMENTS

Hereinafter, an embodiment will be described with reference to the accompanying drawings. The following embodiment does not limit the present disclosure, and not all of elements described in the following embodiment are necessary to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Parking Lot Management System

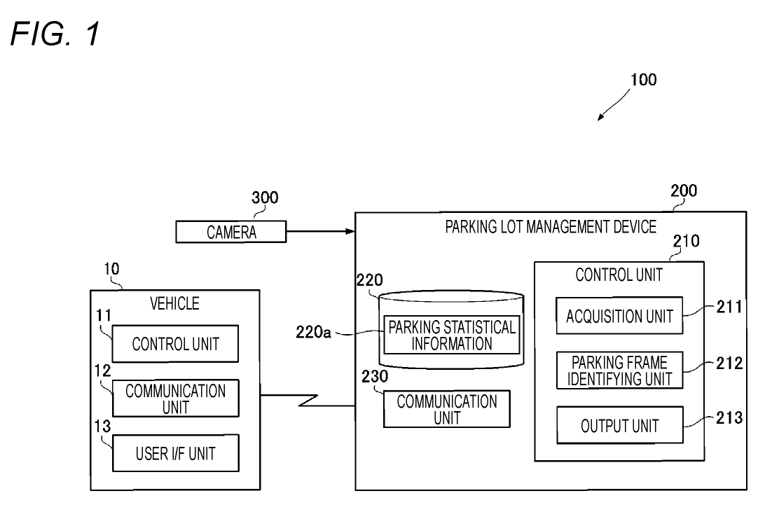

FIG. 1 is a block diagram illustrating an overview of a parking lot management system 100. The parking lot management system 100 is a system that identifies a parking frame, from among a plurality of parking frames provided in a parking lot, to which a user who desires to use the parking lot is guided, and guides the user to the identified parking frame.

The parking lot is, for example, a space in which previously regulated parking frames are provided, and a plurality of vehicles can be parked. Each of the parking frames may be provided for each vehicle size, for example, a small vehicle such as a light automobile or a compact car, a standard (medium) vehicle, or a large vehicle. The parking lot is assumed to be, for example, a parking lot provided in a commercial facility or the like, a general coin parking, or the like. The parking lot is also assumed to be, for example, a parking space in a plaza, a riverbed, an event venue, or the like.

The parking lot management system 100 includes a parking lot management device 200 and a vehicle 10, and the parking lot management device 200 and the vehicle 10 can communicate with each other. That is, the parking lot management device 200 and the vehicle 10 cooperate with each other. In the embodiment, as an example, the parking lot management device 200 performs processing of identifying a parking frame to which the user is guided, and the vehicle 10 receives the guidance on the identified parking frame and notifies the user of the parking frame. Hereinafter, configurations of the parking lot management device 200 and the vehicle 10 will be described.

### Parking Lot Management Device

The parking lot management device 200 is a device that identifies a parking frame to which the user is guided, and includes, for example, a server device, and a general-purpose computer. The parking lot management device 200 is installed in, for example, a site of a parking lot or a management facility that manages the parking lot.

The parking lot management device 200 is connected to a camera 300 capable of detecting entry of a vehicle into the parking lot. The camera 300 may be attached at a position where the entry of the vehicle 10 into the parking lot can be detected, and is installed at, for example, an entrance or an exit of the parking lot. The camera 300 may also serve as a monitoring camera, a security camera, or the like.

The camera 300 only needs to be able to detect at least the entry of the vehicle 10 into the parking lot, but may also be configured to detect, for example, exit of the vehicle 10 to the outside of the parking lot or a parking frame in which the vehicle 10 is parked. The camera 300 is not limited to one camera, and a plurality of cameras may be installed.

The parking lot management device 200 and the camera 300 may be connected by wired communication or wireless communication, or may be connected via another information processing device or the like.

Information acquired by the camera 300 is output to the parking lot management device 200 and stored in a storage unit 220.

The parking lot management device 200 includes a control unit 210 including a CPU, a RAM, a ROM, and the like, the storage unit 220 including a non-transitory storage medium that stores various types of information, and a communication unit 230. The storage unit 220 stores various programs and various types of data. The communication unit 230 is a circuit for communicating with various vehicles including the vehicle 10 and external devices such as the camera 300 described above. The control unit 210 executes a predetermined program stored in the storage unit 220, the ROM, or the like.

The storage unit 220 stores parking statistical information 220a. The parking statistical information 220a stores information (hereinafter, also referred to as attribute information) indicating an attribute of a vehicle parked in the past in each of the plurality of parking frames, and route information to the parking frame. That is, information indicating which vehicle is parked in each parking frame along which route is stored. The parking frame to which the user is guided is identified based on the parking statistical information 220a. The attribute information and the route information of the vehicle parked in each parking frame are, for example, transmitted to and accumulated in the parking lot management device 200 according to the parking of each vehicle. For example, the parking lot management device 200 acquires the attribute information and the route information of each vehicle via the communication unit 230, and stores the acquired information as the parking statistical information 220a.

A timing at which the attribute information and the route information are transmitted from each vehicle to the parking lot management device 200 may be a predetermined timing, and may be assumed to be, for example, a timing at which the parking is completed or a timing at which an ignition power supply is turned off. In addition, the transmission may be performed every predetermined period.

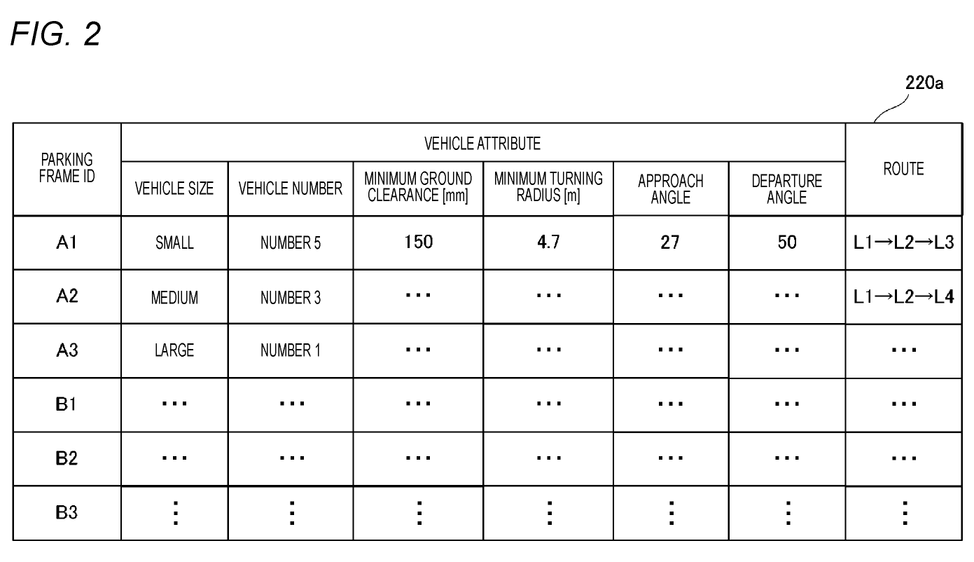

FIG. 2 is a diagram illustrating an example of the parking statistical information 220a. As described above, the parking statistical information 220a stores information on "what attributes does a vehicle have is parked in the parking frame along which route". That is, information on the attribute and the route of the parked vehicle is stored in association with each parking frame in the parking lot. Here, identification information on each parking frame is indicated by a symbol such as "A1".

The attribute of the vehicle includes information on a vehicle size, a vehicle number, a minimum ground clearance, a minimum turning radius, an approach angle, and a departure angle. Each of these pieces of information is an example, and the parking statistical information 220a may include information with which an approximate dimension of the vehicle can be grasped. In the embodiment, it is preferable that the attribute information includes at least the vehicle size and any one of information on the vehicle number, the minimum ground clearance, the minimum turning radius, the approach angle, and the departure angle.

The vehicle size is, for example, information indicating a dimension of the vehicle, which is categorized based on an entire length, an entire width, or an entire height of the vehicle. In the embodiment, the vehicle size is regulated and divided into three categories, small, medium, and large. The number of categories is not limited to three, as long as there are a plurality of categories. The vehicle size may be information indicating the dimension of the vehicle, and may be defined by, for example, the entire length, the entire width, or the entire height of the vehicle.

The vehicle number indicates identification information of the vehicle. The vehicle number may include at least information indicating the dimension of the vehicle and information indicating the user. In the embodiment, the information indicating the dimension of the vehicle in the identification information of the vehicle includes the vehicle number indicating a classification of an automobile. For example, information such as "Number 3" indicating an ordinary passenger car or "Number 5" indicating a small passenger car is included.

The minimum ground clearance is information indicating a vertical distance from a horizontal ground surface (road surface) to the lowest portion of a vehicle body. The minimum ground clearance may be considered in relation to a height of a lock device provided in a coin parking or the like, for example.

The minimum turning radius indicates a radius of a circle drawn by a center of the outermost wheel when turning with a steering turned to the maximum. The minimum turning radius is, for example, an index related to the ease of turning of the vehicle, and may be taken into consideration when identifying the parking frame to which the user is guided because a harmful effect such as difficulty in parking may occur depending on a position of the parking frame.

The approach angle is information indicating an angle between the road surface and a tangent line drawn from a bottom surface of a front bumper to a ground contact surface of a front wheel, and is an index indicating interference between the front bumper and the road surface. That is, the larger the approach angle, the less likely the front bumper is to interfere with the road surface.

The departure angle is information indicating an angle between the road surface and a tangent line drawn from a bottom surface of a rear bumper to a ground contact surface of a rear wheel, and is an index indicating interference between the rear bumper and the road surface. That is, the larger the departure angle, the less likely the rear bumper is to interfere with the road surface.

The route indicates information on a route from when each vehicle enters the parking lot to when the vehicle is parked in the parking frame. The route may be defined by, for example, a link indicating a road in the parking lot. In the embodiment, as an example, a route followed until the vehicle reaches the parking frame is indicated by "L1" or the like. The information on the route may be defined by other information such as a node as long as the route to the parking frame can be grasped.

In the parking statistical information 220a illustrated in FIG. 2, for example, the information on each of the minimum ground clearance, the minimum turning radius, the approach angle, and the departure angle is indicated by a specific numerical value, but it is preferable that the numerical value is converted into and stored as a numerical value of a predetermined range or the like when being stored in the storage unit 220. This is because it is difficult to assume that such numerical values completely match attribute information of the vehicle 10 of the user unless the vehicle types or the like are the same. For example, when the minimum ground clearance of a predetermined parked vehicle is 150 [mm], a value of a predetermined range such as 130 [mm] to 170 [mm] may be used. Such value conversion may be performed when, for example, the parking frame to which the user is guided is identified by the control unit 210 described below, in addition to when the value is stored in the storage unit 220. In addition, a parameter indicated by a numerical value may be similarly converted into a value of a predetermined range.

In addition, in the parking statistical information 220a illustrated in FIG. 2, information on an attribute and a route of one vehicle is indicated in each parking frame such as the parking frame ID "A1", but it can be assumed that a plurality of vehicles are parked in each parking frame in the past. Therefore, although not illustrated here, information on attributes and routes of a plurality of vehicles may be stored in each parking frame. As the number of pieces of data increases, more accurate information is obtained.

In the parking statistical information 220a defined as described above, for example, when the parking statistical information on one parking frame (for example, the parking frame ID "A1") is representatively described, it is possible to grasp that "a small vehicle having Number 5, a minimum ground clearance of 150 [mm], a minimum turning radius of 4.7 [m], an approach angle of 27 [°], and a departure angle of 50 [°] is parked at the parking frame ID "A1" along routes in the order of routes "L1, L2, and L3"".

As described above, traveling data from each vehicle is transmitted to the parking lot management device 200 according to the parking of each vehicle, and thus can be updated every predetermined period.

The control unit 210 executes various programs stored in the storage unit 220. In the related art, a technique of allocating a parking frame is known, but in order to identify the parking frame, various sensors such as a sensor that detects a passage through which a vehicle can pass or detects a parking frame in which a vehicle can be parked need to be mounted on the vehicle, and in such a case, the vehicle cost may increase. Therefore, in the embodiment, in order to prevent an increase in vehicle cost, a predetermined program for identifying a parking frame suitable for the vehicle 10 of the user is executed using a tendency of a similar vehicle that is similar to the vehicle 10 of the user.

Specifically, the control unit 210 includes an acquisition unit 211, a parking frame identifying unit 212, and an output unit 213 as functional units implemented by executing the predetermined program. In the following, processing described as being executed by the acquisition unit 211, the parking frame identifying unit 212, and the output unit 213 is processing implemented by the control unit 210.

The acquisition unit 211 acquires attribute information indicating an attribute of the vehicle 10 of the user. For example, the acquisition unit 211 acquires the attribute information of the vehicle 10 via the communication unit 230. Here, the attribute information may be the same as the information described in the parking statistical information 220a described above, and is, for example, information such as a vehicle size, a vehicle number, a minimum ground clearance, a minimum turning radius, an approach angle, and a departure angle. As the attribute information of the vehicle 10, an approximate dimension of the vehicle 10 may be grasped, and thus the acquisition unit 211 acquires, for example, information indicating the vehicle size of the vehicle 10 through communication with the vehicle 10. In addition, for example, it is preferable to acquire at least one of information on the vehicle number, the minimum ground clearance, the minimum turning radius, the approach angle, and the departure angle.

As described above, the parking lot management device 200 is communicably connected to the camera 300, and thus may be configured to acquire the information such as the vehicle size, the vehicle number, the minimum ground clearance, the minimum turning radius, the approach angle, and the departure angle by acquiring information captured by the camera 300, for example, when the vehicle 10 enters the parking lot.

The acquisition unit 211 acquires, from the vehicle 10 via the communication unit 230, information on a parking frame selected according to a result of guidance by a function of the output unit 213 described later. That is, the information on the parking frame in which the user parks is acquired. As a result, the parking lot management device 200 can grasp whether the user parks in the parking frame to which the user is guided and grasp a tendency of the parking frame selected according to the guidance.

When the acquisition unit 211 acquires the information on the parking frame selected according to the result of the guidance by the function of the output unit 213 as described above, the acquisition unit 211 updates the parking statistical information 220a based on the acquired information on the parking frame. By updating the parking statistical information 220a according to the selection of the parking frame, it is possible to construct more accurate data.

When the parking frame to which the user is guided by the function of the output unit 213 is different from a parking frame in which the vehicle is actually parked, the acquisition unit 211 preferably associates user information with the parking statistical information 220a in accordance with the update in order to identify whether the selection of the different parking frame is, for example, a selection specific to the user. The user information can be acquired from, for example, the vehicle number.

As described above, by storing the user information in association with the parking statistical information 220a, for example, when a predetermined percentage or more of users park in a parking frame different from the parking frame to which the users are guided, there is a possibility that the parking frame to which the user is guided based on the vehicle size or the like is not appropriate, rather than specific to the user, and thus the parking frame to which the user is guided can be updated according to the parking frame in which the vehicle is actually parked. On the other hand, for example, when only a specific user parks in a parking frame different from the parking frame to which the user is guided, it can be assumed that the parking frame is selected according to a convenience, a preference, or the like of the user, and it can be determined that it is not necessary to update the parking frame to which the user is guided. In this case, since the user information is associated with the parking statistical information 220a, only a target user may be guided to a different parking frame in the next and subsequent guidance.

The parking frame identifying unit 212 identifies a parking frame to which the user is guided. Specifically, the parking frame identifying unit 212 refers to the parking statistical information 220a described above, extracts a parking frame in which the similar vehicle that is similar to the vehicle 10 of the user is parked in the past, and identifies the extracted parking frame as the parking frame to which the user is guided. That is, the parking frame identifying unit 212 refers to the attribute information of the vehicle parked in the past in each parking frame in the parking lot, and identifies the parking frame to which the user is guided using the tendency of the similar vehicle.

Here, the "similar vehicle" indicates, for example, a vehicle that satisfies a condition of a predetermined parameter among the attribute information in the parking statistical information 220a described above. For example, when a condition of a predetermined parameter (for example, vehicle size) in the attribute information is the same, a vehicle is regarded as the similar vehicle to the vehicle 10 of the user, or when conditions of at least a predetermined number or more (for example, two or more) of parameters in the attribute information are the same, a vehicle is regarded as the similar vehicle to the vehicle 10 of the user. The definition of such a similar vehicle may be freely defined by, for example, a manufacturer.

The number of parking frames identified by the parking frame identifying unit 212 is not limited to one, and may be multiple. That is, there may be a plurality of parking frames that may be guidance candidates for the user.

When the parking frame identified to which the user is guided is different from the parking frame in which the user actually parks, the parking frame identifying unit 212 updates the parking statistical information according to the tendency of the parking frame in which the user actually parks. As described above, the parking frame identifying unit 212 refers to the parking statistical information 220a and identifies, for example, a parking frame in which the similar vehicle is parked as the parking frame to which the user is guided, but for example, even in a case where the vehicle size is the same, there may be a case where the vehicle has a tendency to be parked in a parking frame different from the parking frame to which the user is guided depending on a specific vehicle type.

For example, when a minivan and an SUV are in the same vehicle size category, it is assumed that the minivan and the SUV are guided to the same parking frame because vehicle sizes thereof are the same. In general, a slide door is often adopted for the minivan, but a slide door is not often adopted for the SUV, as compared with the minivan. In such a case, for a lateral width of the parking frame, a user of the minivan may not be concerned about a dimension of the lateral width of the parking frame as long as the parking frame is wide enough for entry and exit. On the other hand, for the lateral width of the parking frame, a user of the SUV may be concerned about the dimension of the lateral width of the parking frame in view of opening and closing of a door at the time of entering and exiting. Therefore, even if the vehicles of the same vehicle size are guided to the same parking frame, the parking frames in which the user of the minivan and the user of the SUV actually park may be different. Such a tendency may change in a process of accumulating the parking statistical information 220a.

Therefore, the parking frame identifying unit 212 acquires information on the parking frame in which the user parks according to the guidance on the parking frame, and for example, when a predetermined percentage or more of vehicles are parked in a parking frame different from the parking frame to which the user is guided based on the vehicle size, the parking frame identifying unit 212 updates the parking frame to which the user is guided to the parking frames in which the predetermined percentage or more of vehicles are parked. That is, when the tendency of the parking frame in which the vehicle is actually parked is different from a tendency of the parking frame to which the user is guided based on the vehicle size, the parking frame identifying unit 212 updates the parking frame to which the user is guided according to the tendency. This is to provide guidance corresponding to the information on the parking frame in which each user actually parks.

Here, as an example of updating the parking frame to which the user is guided, an example in which the parking frame to which the user is guided based on the information on the vehicle size is different from the parking frame in which the vehicle is actually parked has been described, but the present disclosure is not limited to the vehicle size, and the same processing may be applied to a case where the parking frame to which the user is guided based on other parameters is different from the parking frame in which the vehicle is actually parked. For example, when a parking frame to which the user is guided based on the information on the vehicle number is different from the parking frame in which the vehicle is actually parked, and a predetermined percentage or more of vehicles are parked in a parking frame different from the parking frame to which the user is guided, the parking frame identifying unit 212 may update the parking frame to which the user is guided, according to a tendency of the parking frame in which the vehicle is actually parked.

The output unit 213 guides the user to the parking frame identified by the function of the parking frame identifying unit 212. That is, the output unit 213 transmits information on the parking frame identified by the parking frame identifying unit 212 to the vehicle 10 via the communication unit 230. The transmitted information is received by the vehicle 10. The vehicle 10 guides the user to the parking frame by notifying the user of the parking frame by a predetermined means such as displaying the parking frame on a predetermined display unit such as a touch panel or outputting the parking frame by voice. The display unit as a notification destination may be, for example, a portable terminal such as a smartphone of the user.

### Vehicle

Next, a configuration of the vehicle 10 of the user who receives the guidance on the parking frame from the parking lot management device 200 will be described. The vehicle 10 may be a vehicle capable of notifying the user of the parking frame by, for example, displaying the guidance on the parking frame received from the parking lot management device 200 on a predetermined display unit or the like. That is, the vehicle may be a vehicle capable of performing parking assistance (or driving assistance) of at least notifying the user of the parking frame. Therefore, the vehicle that may be a target may be, for example, an internal combustion engine vehicle including an internal combustion engine such as a gasoline engine or a diesel engine as a drive source, or may be an electric automobile including an electric motor. Alternatively, the vehicle may be a hybrid vehicle including an internal combustion engine and an electric motor or the like. The vehicle may be a vehicle having other predetermined functions or the like of driving assistance and automatic driving.

As illustrated in FIG. 1, the vehicle 10 includes a control unit 11, a communication unit 12, and a user I/F unit 13. The control unit 11 is a computer including a CPU, a RAM, a ROM, and the like.

The communication unit 12 includes a circuit for communicating with other devices. In the embodiment, the vehicle 10 can communicate with the parking lot management device 200 via the communication unit 12, and exchange various types of information. For example, the vehicle 10 receives the guidance on the parking frame from the parking lot management device 200, or transmits the attribute information of the vehicle 10, information on the parking frame in which the vehicle is parked, and the like to the parking lot management device 200.

The user I/F unit 13 is an interface unit for inputting an instruction of the user and providing various types of information to the user, and includes a display unit including a touch panel display (not illustrated), an input unit such as a switch, and an output unit such as a speaker. In the embodiment, the information on the parking frame transmitted from the parking lot management device 200 is displayed on the display unit of the user I/F unit 13 or output from the speaker.

The control unit 11 can execute a predetermined program stored in a storage unit (not illustrated) or the like. For example, the control unit 11 executes a predetermined program for guiding the user to the parking frame. Specifically, the control unit 11 receives the information on the parking frame transmitted from the parking lot management device 200, and performs control to display the received information on the parking frame on the display unit of the user I/F unit 13. When the displayed parking frame is selected by the user, the control unit 11 performs control such as displaying a route to the parking frame and performing guidance.

### Sequence Chart

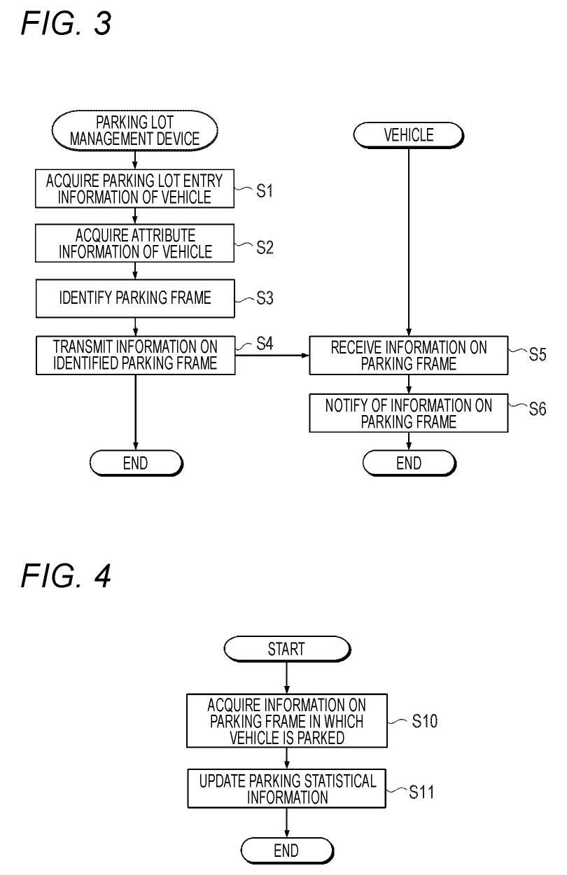

Next, an example of processing executed in the embodiment will be described with reference to a sequence chart. FIG. 3 is a sequence chart illustrating an example of the processing, and the parking lot management device 200 and the vehicle 10 cooperate to perform the processing. As described above, the parking lot management device 200 identifies a parking frame to which the user is guided and transmits information on the identified parking frame to the vehicle 10. The vehicle 10 displays the guidance on the parking frame received from the parking lot management device 200 on the display unit or the like. Since a specific content of each processing in the parking lot management device 200 and the vehicle 10 is as described above, here, the flow of the processing will be mainly described, and the detailed description of the processing will be omitted or simplified.

First, in step S1, the control unit 210 in the parking lot management device 200 acquires parking lot entry information of the vehicle 10. That is, the control unit 210 acquires information indicating that the vehicle 10 enters the parking lot, and starts identifying the parking frame to which the user is guided with the acquisition of the parking lot entry information as a trigger. Specifically, the information indicating that the vehicle 10 enters the parking lot is acquired by the camera 300. Then, the control unit 210 acquires the information indicating that the vehicle 10 enters the parking lot from the camera 300 via the communication unit 230.

Next, in step S2, the control unit 210 acquires the attribute information of the vehicle 10. That is, the attribute information such as the vehicle size, the vehicle number, the minimum ground clearance, the minimum turning radius, the approach angle, and the departure angle of the vehicle 10 is acquired. Here, as an example, the description will be given assuming that the information on the vehicle size is acquired from the vehicle 10. The attribute information of the vehicle 10 may be acquired by communication with the vehicle 10, or, for example, when the vehicle 10 enters the parking lot in step S1, the vehicle size and the like may be acquired by the camera 300 together with the information indicating that the vehicle 10 enters the parking lot.

Next, in step S3, the control unit 210 identifies the parking frame to which the user is guided. Specifically, the control unit 210 identifies a similar vehicle that is similar to the vehicle 10 of the user with reference to the parking statistical information 220a. That is, a similar vehicle having the same size as the vehicle size of the user is identified. Then, a parking frame in which the identified similar vehicle is parked in the past is extracted. The control unit 210 identifies the extracted parking frame as the parking frame to which the user is guided. In this case, a plurality of parking frames may be identified as described above.

Next, in step S4, the control unit 210 transmits the information on the parking frame identified in step S3 to the vehicle 10. That is, the control unit 210 transmits the information on the identified parking frame to the vehicle 10 via the communication unit 230. Accordingly, it is possible to transmit the information on the parking frame to which the user is guided. The control unit 210 may transmit route information to the parking frame together with the transmission of the information on the parking frame. After transmitting the information on the parking frame to the vehicle 10, the control unit 210 may store the transmitted information on the parking frame in the storage unit 220 or may store the transmitted information on the parking frame as a part of the parking statistical information 220a. After transmitting the information on the parking frame to the vehicle 10, the control unit 210 ends the processing shown in FIG. 3.

According to processing of step S4, the vehicle 10 receives the information on the parking frame from the parking lot management device 200 (step S5). That is, the control unit 11 in the vehicle 10 acquires the information on the parking frame to which the user is guided from the parking lot management device 200 via the communication unit 12.

Then, the vehicle 10 notifies the user of the information on the parking frame received in step S5 (step S6). For example, the control unit 11 displays the information on the parking frame on the display unit in the user I/F unit 13. Alternatively, the user may be notified of the information on the parking frame via the speaker in the user I/F unit 13. Accordingly, the user can select the parking frame based on the displayed information on the parking frame or the like.

### Update Processing of Parking Statistical Information

Next, update processing of the parking statistical information 220a in the parking lot management device 200 will be described. FIG. 4 is a flowchart illustrating an example of the update processing. As described above, the parking lot management device 200 identifies the parking frame to which the user is guided and transmits the information on the identified parking frame to the vehicle 10 of the user, but since information on a parking frame in which the user actually parks is unknown, it is preferable to acquire the information on the parking frame in which the user actually parks and update the parking statistical information 220a.

Therefore, the control unit 210 acquires the information on the parking frame in which the vehicle 10 is parked from the vehicle 10 (step S10). That is, the control unit 210 acquires the information on the parking frame in which the vehicle 10 is actually parked from the vehicle 10 via the communication unit 230. When the parking frame in which the vehicle 10 is parked can be grasped by the camera 300 installed in the parking lot, the control unit 210 may acquire the information on the parking frame in which the vehicle 10 is parked based on the information in the camera 300.

Next, the control unit 210 updates the parking statistical information 220a based on the information on the parking frame in which the vehicle 10 is parked acquired in step S10 (step S11). That is, the information on the parking frame in which the vehicle 10 is parked is reflected in the parking statistical information 220a. At this time, for example, the control unit 210 preferably stores a correlation between the information on the parking frame to which the user is guided and the information on the parking frame in which the vehicle is actually parked. This is because, for example, when the information on the parking frame to which the user is guided is different from the information on the parking frame in which the vehicle is actually parked, it may be necessary to update the information on the parking frame to which the user is to be guided in the next and subsequent guidance. That is, the information on the parking frame in which the vehicle is actually parked is accumulated, and the information on the parking frame to which the user is guided is also updated based on the accumulated information. As a result, the accurate parking statistical information 220a is sequentially updated or generated, and it is possible to provide the guidance on the parking frame based on the updated information.

As described above, for the update of the parking frame to which the user is guided, for example, in a case where there is a tendency that a predetermined percentage or more of vehicles are parked in a parking frame different from the parking frame to which the user is guided, the parking frame to which the user is guided may be updated according to the tendency.

As described above, in the embodiment, the parking lot management device 200 identifies the parking frame in which the similar vehicle that is similar to the vehicle 10 of the user is parked in the past as the parking frame to which the user is guided, based on the parking statistical information 220a including the attribute information of the vehicle parked in the past in each of the plurality of parking frames. That is, the parking lot management device 200 is configured to identify the parking frame to which the user is guided, using the tendency of the similar vehicle that is similar to the vehicle 10 of the user. Therefore, for example, in determining the route to the parking frame or identifying the parking frame, a large number of sensors or the like are not required as compared with a configuration in the related art such as the device described in JP2023-053667A. Therefore, it is possible to identify the parking frame to which the user is guided at low cost.

As described above, the user who receives the guidance on the parking frame can save the time and effort of searching for the parking frame suitable for the vehicle 10 of the user.

In addition, the parking statistical information 220a includes the route information until parking in each parking frame. Therefore, the parking lot management device 200 can guide the user along the route to the parking frame, in addition to the guidance on the parking frame. Accordingly, for example, it is possible to provide the guidance on the parking frame without considering a route to the parking frame. In other words, the driving assistance and the parking assistance can be performed without relying on various sensors and the like necessary for sensing.

In the embodiment, the parking lot management device 200 acquires, from the user, the information on the parking frame selected according to the result of the guidance by the function of the output unit 213, and updates the parking statistical information 220a based on the acquired information on the parking frame. As described above, by updating the parking statistical information 220a, the parking statistical information 220a is updated according to the parking of the user, and thus it is possible to identify the parking frame to which the user is guided based on more accurate information.

The attribute information of the vehicle included in the parking statistical information 220a may include the vehicle size, the minimum ground clearance, the minimum turning radius, the vehicle number, the approach angle, the departure angle, and the like. These pieces of information are information indicating the dimension of the vehicle. Therefore, by identifying the parking frame to which the user is guided based on such information, it is possible to identify the parking frame suitable for the vehicle 10 of the user.

In the embodiment, the parking lot management device 200 acquires the attribute information of the vehicle 10 and the information on the parking frame in which the vehicle 10 is actually parked by communication with the vehicle 10 or based on the information acquired by the camera 300 installed in the parking lot. That is, it is possible to identify the parking frame to which the user is guided, using a configuration known in the related art (in other words, an existing configuration). That is, it is possible to identify an appropriate parking frame with a simple configuration without requiring a new configuration, a complicated configuration, or the like.

In the embodiment, the parking lot management device 200 updates the parking frame to which the user is guided, when the parking frame to which the user is guided by the function of the output unit 213 is different from the parking frame in which the vehicle 10 of the user is actually parked, for example, when the predetermined percentage or more of vehicles are parked in the parking frame different from the parking frame to which the user is guided based on the vehicle size. That is, when the parking frame in which the vehicle 10 is actually parked is different from the parking frame to which the user is guided, the parking frame to which the user is guided is updated according to the tendency. Accordingly, for example, even if the vehicle sizes are similar (for example, medium), such as a minivan and an SUV, when the tendencies of the parking frame are different, it is possible to provide the guidance on the parking frame for each vehicle, and as a result, it is possible to provide the guidance on the parking frame suitable for the user.

In the embodiment, when the parking frame to which the user is guided by the function of the output unit 213 is different from the parking frame in which the vehicle 10 of the user is actually parked, the parking lot management device 200 acquires the user information from the vehicle number and updates the parking statistical information 220a in association with the acquired user information. Accordingly, for example, when a predetermined percentage or more of users park in a parking frame different from the parking frame to which the users are guided, it can be determined that there is a possibility that the parking frame to which the user is guided based on the vehicle size or the like is not appropriate, rather than specific to the user. Then, by updating the parking frame to which the user is guided according to the parking frame in which the vehicle is actually parked, it is possible to provide the guidance on the parking frame appropriately according to a usage tendency of each user. On the other hand, for example, when only a specific user parks in a parking frame different from the parking frame to which the user is guided, the parking frame is selected according to a convenience, a preference, or the like of the user, and thus it can be determined that it is not necessary to update the parking frame to which the user is guided. In this case, since the user information is associated with the parking statistical information 220a, only a target user may be guided to a different parking frame in the next and subsequent guidance.

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure. In addition, constituent elements in the embodiment described above may be freely combined without departing from the gist of the present disclosure.

For example, the parking statistical information 220a described with reference to FIG. 2 is not limited to the information included in FIG. 2 as long as the information can indicate the dimension of the vehicle when the parking frame to which the user is guided is identified. For example, an engine displacement may be included. In addition, as the route information described above, information for guiding the user to the parking frame may be included. That is, the parking statistical information 220a may include information that can reduce the time and effort of the user or the like in a process of parking in an appropriate parking frame while guiding the user to the parking frame.

In the embodiment described above, an example in which the parking frame to which the user is guided is identified mainly based on, for example, the vehicle size in the parking statistical information 220a when the user is guided to the parking frame has been described, but when the parking frame to which the user is guided is identified, for example, the parking frame to which the user is guided may be identified based on a plurality of parameters such as all parameters of the parking statistical information 220a. As the number of parameters to be referred to increases, more accurate guidance on the parking frame becomes possible.

In the embodiment described above, when identifying the parking frame to which the user is guided, the parking lot management device 200 may acquire, for example, vacancy information of parking frames in the current parking lot in addition to the parking statistical information 220a, and identify the parking frame to which the user is guided in consideration of the vacancy information. For example, the parking lot management device 200 may be configured to acquire the vacancy information of the parking frames based on the information acquired by the camera 300, or may be configured to acquire a vacancy situation by communication with a device that manages the vacancy situation of the parking frame or the like. Accordingly, for example, it is possible to avoid a situation in which the parking frame to which the user is guided is occupied, and it is possible to guide the user to a more appropriate parking frame.

The configurations of the embodiment described above may share functions or may be implemented by fewer devices and the like. For example, at least a part of the configurations of the parking lot management device 200 may be implemented by the control unit 11 of the vehicle 10 or the like.

For example, at least a part of units (the acquisition unit 211, the parking frame identifying unit 212, and the output unit 213) constituting the control unit 210 of the parking lot management device 200 may be separated and present in a plurality of devices. For example, the parking lot management device 200 may be implemented by a cloud server or the like.

Further, a part of the configurations of the embodiment described above may be omitted, or the processing may be changed or omitted.

The processing described in the above embodiment can be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

In the present description, at least the following matters are described. Although corresponding constituent elements in the embodiment described above are shown in parentheses, the present disclosure is not limited thereto.

(1) A parking lot management device (parking lot management device 200) that identifies, from among a plurality of parking frames provided in a parking lot, a parking frame to which a user who desires to use the parking lot is guided, the parking lot management device including a processor (acquisition unit 211, parking frame identifying unit 212, output unit 213) configured to:

acquire attribute information indicating an attribute of a vehicle of the user;

identify, by referring to a storage (storage unit 220) that stores parking statistical information (parking statistical information 220a) including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and

perform guidance for the user to the identified parking frame.

According to (1), the parking frame to which the user is guided is identified using a tendency of the similar vehicle that is similar to the vehicle of the user. Therefore, for example, in determining a route to the parking frame or identifying the parking frame, a large number of sensors or the like are not required. Therefore, it is possible to identify the parking frame to which the user is guided at low cost. With such guidance, it is possible to save the time and effort of the user who searches for the parking frame.

(2) The parking lot management device according to (1), in which

the processor is configured to acquire information on a parking frame selected according to a result of the guidance, and update the parking statistical information based on the acquired information on the parking frame.

According to (2), the parking statistical information is updated based on information on a parking frame in which the user actually parks, and thus it is possible to identify the parking frame to which the user is guided and to provide the guidance in the parking lot based on more accurate information.

(3) The parking lot management device according to (1) or (2), in which

the parking statistical information includes route information until parking in the parking frame.

According to (3), since the route information is included in the parking statistical information, it is possible to provide the guidance on the route to the parking frame, in addition to the parking frame. Accordingly, for example, it is possible to provide the guidance on the parking frame without considering a route to the parking frame. In other words, driving assistance and parking assistance can be performed without relying on various sensors and the like necessary for sensing.

(4) The parking lot management device according to (1) or (2), in which

the attribute information includes at least one of information on a vehicle size, a minimum ground clearance, a minimum turning radius, a vehicle number indicating identification information, an approach angle, and a departure angle of the vehicle of the user.

According to (4), since the attribute information includes information on a dimension of the vehicle such as the vehicle size, it is possible to provide the guidance on the parking frame based on a tendency of vehicles of the same vehicle class.

(5) The parking lot management device according to (4), in which (camera 300) configured to acquire the attribute information, and

the processor is configured to acquire the information on the vehicle size based on the information captured by the imager.

According to (5), the vehicle size can be acquired based on the information acquired by the imaging unit.

(6) The parking lot management device according to (5), in which

the processor is configured to acquire at least one of the information on the minimum ground clearance, the minimum turning radius, the vehicle number, the approach angle, and the departure angle based on the information captured by the imager.

According to (6), it is possible to acquire the information on the minimum ground clearance, the minimum turning radius, the vehicle number, the approach angle, the departure angle, and the like based on the information acquired by the imaging unit.

(7) The parking lot management device according to (1) or (2), in which

the processor is configured to acquire the attribute information via a communicator (communication unit 230) configured to communicate with the vehicle of the user.

According to (7), since the attribute information can be acquired through the communication with the vehicle of the user, more accurate attribute information such as the vehicle size can be acquired, for example, as compared with a case where the attribute information is acquired by various sensors, devices, or the like.

(8) The parking lot management device according to (1) or (2), in which

the processor is configured to acquire, via a communicator (communication unit 230) configured to communicate with the vehicle of the user, information on the parking frame selected according to a result of the guidance.

According to (8), it is possible to acquire the information on the parking frame in which the vehicle is actually parked through the communication with the vehicle of the user, and by reflecting the information in the parking statistical information, it is possible to generate more accurate parking statistical information and identify the parking frame to which the user is guided.

(9) The parking lot management device according to (4), in which

when the parking frame to which the user is guided is different from a parking frame in which the vehicle of the user is actually parked, the processor updates the parking frame to which the user is guided in a case where a predetermined percentage or more of vehicles are parked in a parking frame different from the parking frame to which the user is guided based on the vehicle size.

According to (9), when the parking frame in which the vehicle is actually parked is different from the parking frame to which the user is guided, the parking frame to which the user is guided is updated according to the tendency. Accordingly, even if the vehicle sizes are similar, when tendencies of the parking frame are different, it is possible to provide the guidance on the parking frame for each vehicle, and as a result, it is possible to provide the guidance on the parking frame suitable for the user.

(10) The parking lot management device according to (4), in which

in a case where the parking frame to which the user is guided is different from a parking frame in which the vehicle of the user is actually parked, the processor acquires user information from the vehicle number and updates the parking statistical information in association with the acquired user information.

According to (10), by associating the user information with the parking statistical information, for example, information on a parking frame specific to the user can be stored, and it is possible to provide the guidance on the parking frame suitable for the user in the next and subsequent guidance.

(11) The parking lot management device according to (10), in which

when the parking frame to which the user is guided is different from a parking frame in which the vehicle of the user is actually parked, the processor updates the parking frame to which the user is guided in a case where, with respect to the parking frame to which the user is guided, a predetermined percentage or more of vehicles of users are parked in a parking frame different from the parking frame to which the user is guided.

According to (11), for example, when the predetermined percentage or more of users park in the parking frame different from the parking frame to which the users are guided, there is a possibility that the parking frame to which the user is guided based on the vehicle size or the like is not appropriate, rather than specific to the user, and thus it is possible to provide the guidance on the parking frame appropriately according to a usage tendency of each user by updating the parking frame to which the user is guided according to the parking frame in which the vehicle is actually parked.

(12) A parking lot management system (parking lot management system 100) that identifies, from among a plurality of parking frames provided in a parking lot, a parking frame to which a user who desires to use the parking lot is guided, the parking lot management system including:

a parking lot management device (parking lot management device 200) configured to identify the parking frame to which the user is guided; and

a vehicle (vehicle 10) configured to communicate with the parking lot management device and receive guidance on the parking frame, in which

the parking lot management device includes a first processor (control unit 210) configured to acquire attribute information indicating an attribute of the vehicle of the user, identify, by referring to parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user, and perform the guidance for the user to the identified parking frame, and

the vehicle of the user includes a second processor (control unit 11) configured to receive the guidance on the parking frame from the parking lot management device and issue a notification of information on the parking frame based on the received guidance.

According to (12), the parking frame to which the user is guided is identified using a tendency of the similar vehicle that is similar to the vehicle of the user. Therefore, for example, in determining a route to the parking frame or identifying the parking frame, a large number of sensors or the like are not required. Therefore, it is possible to identify the parking frame to which the user is guided at low cost. With such a configuration, the user who receives the guidance on the parking frame can save the time and effort of searching for the parking frame.

(13) A parking lot management method by a computer that identifies, from among a plurality of parking frames provided in a parking lot, a parking frame to which a user who desires to use the parking lot is guided, including:

acquiring attribute information indicating an attribute of a vehicle (vehicle 10) of the user;

identifying, by referring to parking statistical information (parking statistical information 220a) including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and

performing guidance for the user to the identified parking frame.

According to (13), the parking frame to which the user is guided is identified using a tendency of the similar vehicle that is similar to the vehicle of the user. Therefore, for example, in determining a route to the parking frame or identifying the parking frame, a large number of sensors or the like are not required. Therefore, it is possible to identify the parking frame to which the user is guided at low cost. With such guidance, it is possible to save the time and effort of the user who searches for the parking frame.

(14) A non-transitory computer-readable storage medium storing a program causing a computer that identifies, from among a plurality of parking frames provided in a parking lot, a parking frame to which a user who desires to use the parking lot is guided to execute a process, the process including:

acquiring attribute information indicating an attribute of a vehicle (vehicle 10) of the user,

identifying, by referring to parking statistical information (parking statistical information 220a) including attribute information of a vehicle parked in a past in each of the plurality of parking frames, a parking frame in which a similar vehicle that is similar to the vehicle of the user is parked in the past as the parking frame to which the user is guided based on the acquired attribute information of the user, and

performing guidance for the user to the identified parking frame.

According to (14), the parking frame to which the user is guided is identified using a tendency of the similar vehicle that is similar to the vehicle of the user. Therefore, for example, in determining a route to the parking frame or identifying the parking frame, a large number of sensors or the like are not required. Therefore, it is possible to identify the parking frame to which the user is guided at low cost. With such guidance, it is possible to save the time and effort of the user who searches for the parking frame.

What is claimed is:

1. A parking lot management device that identifies, from among a plurality of parking frames provided in a parking lot, a parking frame to which a user who desires to use the parking lot is guided, the parking lot management device comprising a processor configured to:
acquire attribute information indicating an attribute of a vehicle of the user;
identify, by referring to a storage that stores parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and
perform guidance for the user to the identified parking frame.

2. The parking lot management device according to claim 1, wherein
the processor is configured to acquire information on a parking frame selected according to a result of the guidance, and update the parking statistical information based on the acquired information on the parking frame.

3. The parking lot management device according to claim 1, wherein
the parking statistical information includes route information until parking in the parking frame.

4. The parking lot management device according to claim 1, wherein
the attribute information includes at least one of information on a vehicle size, a minimum ground clearance, a minimum turning radius, a vehicle number indicating identification information, an approach angle, and a departure angle of the vehicle of the user.

5. The parking lot management device according to claim 4, wherein
the parking lot management device is connected to an imager configured to acquire the attribute information, and
the processor is configured to acquire the information on the vehicle size based on the information captured by the imager.

6. The parking lot management device according to claim 5, wherein
the processor is configured to acquire at least one of the information on the minimum ground clearance, the minimum turning radius, the vehicle number, the approach angle, and the departure angle based on the information captured by the imager.

7. The parking lot management device according to claim 1, wherein
the processor is configured to acquire the attribute information via a communicator configured to communicate with the vehicle of the user.

8. The parking lot management device according to claim 1, wherein
the processor is configured to acquire, via a communicator configured to communicate with the vehicle of the user, information on the parking frame selected according to a result of the guidance.

9. The parking lot management device according to claim 4, wherein
when the parking frame to which the user is guided is different from a parking frame in which the vehicle of the user is actually parked, the processor updates the parking frame to which the user is guided in a case where a predetermined percentage or more of vehicles are parked in a parking frame different from the parking frame to which the user is guided based on the vehicle size.

10. The parking lot management device according to claim 4, wherein
in a case where the parking frame to which the user is guided is different from a parking frame in which the vehicle of the user is actually parked, the processor acquires user information from the vehicle number and updates the parking statistical information in association with the acquired user information.

11. The parking lot management device according to claim 10, wherein
when the parking frame to which the user is guided is different from a parking frame in which the vehicle of the user is actually parked, the processor updates the parking frame to which the user is guided in a case where, with respect to the parking frame to which the user is guided, a predetermined percentage or more of vehicles of users are parked in a parking frame different from the parking frame to which the user is guided.

12. A parking lot management system that identifies, from among a plurality of parking frames provided in a parking lot, a parking frame to which a user who desires to use the parking lot is guided, the parking lot management system comprising:
the parking lot management device according to claim 1; and
a vehicle configured to communicate with the parking lot management device and receive guidance on the parking frame, wherein
the vehicle of the user includes a processor configured to receive the guidance on the parking frame from the parking lot management device and issue a notification of information on the parking frame based on the received guidance.

13. A parking lot management method by a computer that identifies, from among a plurality of parking frames provided in a parking lot, a parking frame to which a user who desires to use the parking lot is guided, comprising:
acquiring attribute information indicating an attribute of a vehicle of the user;
identifying, by referring to parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user; and
performing guidance for the user to the identified parking frame.

14. A non-transitory computer-readable storage medium storing a program causing a computer that identifies, from among a plurality of parking frames provided in a parking lot, a parking frame to which a user who desires to use the parking lot is guided to execute a process, the process comprising:
acquiring attribute information indicating an attribute of a vehicle of the user,
identifying, by referring to parking statistical information including attribute information of a vehicle parked in a past in each of the plurality of parking frames, a parking frame in which a similar vehicle that is similar to the vehicle of the user is parked in the past as the parking frame to which the user is guided based on the acquired attribute information of the user, and
performing guidance for the user to the identified parking frame.
